(19) United States
(12) Patent Application Publication
(10) Pub. No.: US 2021/0251211 A1
(43) Pub. Date: Aug. 19, 2021

(54) Weighted Rotatable Electronic Owl

(71) Applicant: Leon Rashed, San Pablo, CA (US)

(72) Inventor: Leon Rashed, San Pablo, CA (US)

(21) Appl. No.: 16/790,101

(22) Filed: Feb. 13, 2020

(51) Int. Cl. A01M 29/10; A01M 29/16

(52) U.S. Cl. CPC A01M 29/10; A01M 29/16

(57) ABSTRACT

An electronic owl for scaring away pigeons and other unwanted wildlife from homes or other buildings. The electronic owl includes a housing having a body and a rotating head attached thereto. The body of the rotating electronic owl is attached to a weighted base which allows a user to add or subtract the amount and type of material put into the base. The housing includes a variety of motion sensors therein configured to detect birds or other unwanted animals. The electronic owl utilizes motion, lights, and sound to scare away pest animals from the designated area.

### BACKGROUND OF THE INVENTION

The present invention relates to animal deterrents. More specifically, the present invention relates to an electronic owl having a rotatable head wherein motion sensors and speakers are configured to emit owl noises when birds and other unwanted animals enter within a certain proximity.

Pigeon control is important due to the damage and disease these birds often create through their presence and close proximity to humans and food crops. If left unattended, pigeon feces can be corrosive and can cause damage to roofs and other surfaces. Pigeon droppings can also be responsible for a host of serious diseases. Additionally, debris from the flocks of pigeons and other nuisance birds and animals can build up and create a problem through backed up gutters and drains, which can lead to flooding and roof damage. In order to address these concerns, the present invention provides an electronic owl having a variety of features configured to scare away pigeons and other unwanted animals. Accordingly, a device is needed to provide effective deterrence from nesting birds and other nuisance animals.

Devices have been disclosed in the known art that relate to animated pest control devices. These include devices that have been patented and published in patent application publications. These devices include an electronic predator replica which sensing motion via one or more of a plurality of spaced motion sensors and the predator's head rotates to the angle of the sensor that detected the motion. Another device includes a replica of an owl for use in a garden for deterring pests having a first body portion and a second body portion being rotatably mounted thereon. These devices, however, fail to disclose a rotatable replica of an owl having a base that includes a hollow interior volume configured to receive sand or other weighting material, and spikes configured to engage or penetrate the surface it is resting upon.

In light of the devices disclosed in the known art, it is submitted that the present invention substantially diverges in design elements from the known art and consequently it is clear that there is a need in the art for an improvement to existing animated pest control devices. In this regard, the instant invention substantially fulfills these needs.

### SUMMARY OF THE INVENTION

In view of the foregoing disadvantages inherent in the known types of pest animal deterrents now present in the known art, the present invention provides a weighted rotatable electronic owl wherein the same can be utilized for providing convenience for the user when attempting to keep a given area free from nesting birds or other unwanted animals.

It is therefore an object of the present invention to provide a new and improved animated pest control device that has all the advantages of the known art and none of the disadvantages. The present system comprises a body portion, a head member, and a base wherein the base is removably affixed to a bottom end of the body portion while the head member is rotatably attached to a top end of the body portion thereon, while a motor disposed within the body portion is operably attached to a circuit board and power source and configured to rotate the head member.

It is another object of the present invention to provide a weighted rotatable electronic owl wherein the base portion, which is removably attachable from the body portion via a male and female adaption, comprises a hollow compartment having an aperture adapted to receive a weighting material therethrough.

Another object of the present invention is to provide a weighted rotatable electronic owl wherein a plurality of motion sensors are disposed on the exterior of the device and operably connected to the circuit board wherein they are configured to detect motion within a given proximity.

Yet another object of the present invention is to provide a weighted rotatable electronic owl wherein the head member is configured to rotate towards the direction which motion has been detected to ward off pigeons and other pest animals.

Another object of the present invention is to provide a weighted rotatable electronic owl wherein a speaker and two light sources are disposed within the head member such that the light sources correspond with the eye placement of the owl and are configured to illuminate while predator sounds are emitted from the speakers whenever motion is detected within a given proximity.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the weighted rotatable electronic owl.

FIG. 2 shows a perspective view of an embodiment of the weighted rotatable electronic owl.

FIG. 3 shows a perspective view of an embodiment of the weighted rotatable electronic owl showing removably affixable base portion.

FIG. 4 shows a perspective view of an embodiment of the weighted rotatable electronic owl showing removably affixable base portion.

FIG. 5 shows a schematic view of the electronic components of an embodiment of the weighted rotatable electronic owl.

FIG. 6 shows a perspective view of an embodiment of the weighted rotatable electronic owl showing head member.

FIG. 7 shows a perspective view of an embodiment of the weighted rotatable electronic owl installed on the exterior of a building.

### DETAILED DESCRIPTION OF THE INVENTION

Reference is made herein to the attached drawings. Like reference numerals are used throughout the drawings to depict like or similar elements of the weighted rotatable electronic owl. For the purposes of presenting a brief and clear description of the present invention, the preferred embodiment will be discussed as used for scaring away pigeons and other pest animals from desired outdoor spaces. The figures are intended for representative purposes only and should not be considered to be limiting in any respect.

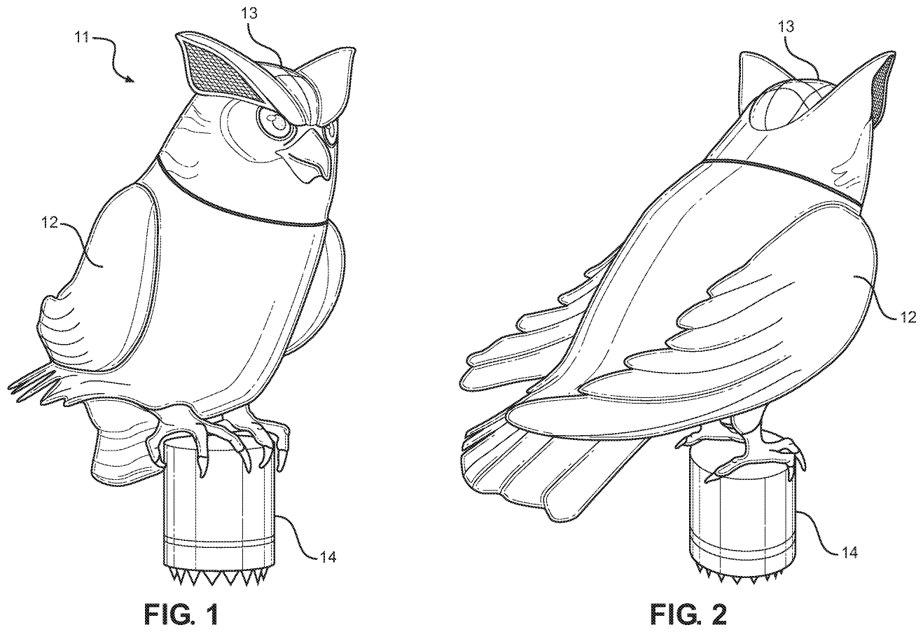

Referring now to FIGS. 1 and 2, there are shown perspective views of an embodiment of the weighted rotatable electronic owl. The weighted rotatable electronic owl 11 comprises a body portion 12 and a rotatably attached head member 13 adapted to resemble the body and head of an owl, respectively. This includes having a coloring, body shape and feather contouring that mimics a real owl for full effect to ward off pigeons and other pest animals from an area selected by a user. The head member 13 is rotatable attached to a top end of the body portion 12. A base member 14 is removably affixable to a bottom end of the body portion 12 of the device 11. The base member 14 of the weighted rotatable electronic owl 11 is painted and configured to resemble the stump of a tree having talons rested on top so to resemble an owl perched and scanning the area.

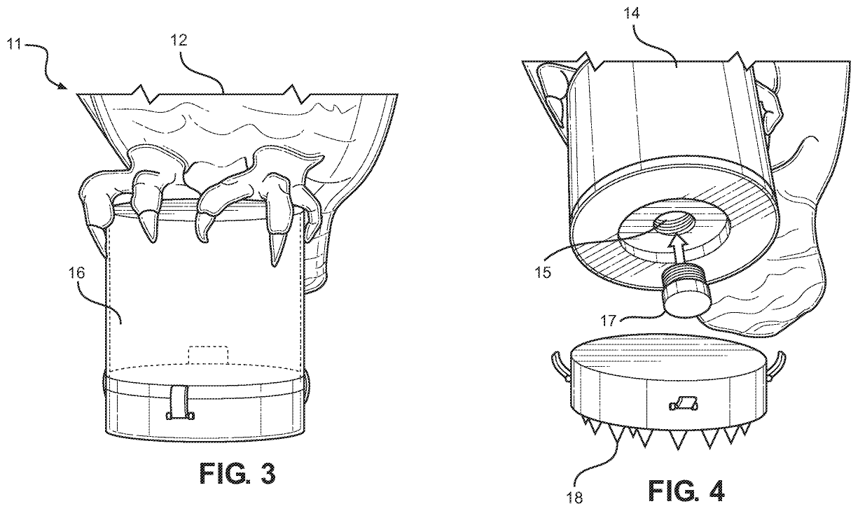

Referring now to FIGS. 3 and 4, there is shown perspective views of embodiments of the weighted rotatable electronic owl showing weighted base portion. In the illustrated embodiment, the base member 14 is cylindrical in shape. The base member 14 is removable affixed to the bottom end of the body portion 12 of the device 11 and adapted to keep the device upright and affixed to a selected surface. A male and female adaption allows for the base 14 to be selectively connected and disconnected from the body portion 12. The base 14 comprises a housing that defines a hollow compartment 16 having an aperture 15 therethrough. In the illustrated embodiment, the base 14 has a hollow cylindrical shape but may be of any suitable shape. Weighting material may be selectively added into the base 14 through the aperture 15 disposed in the top portion of the base 14. The aperture 15 may be selectively opened and closed via a seal 17, such as a plug. The aperture 15 is disposed on a surface of the base 14 between the male and female adaption so as to be covered when the base 14 is affixed to the body portion 12 of the weighted rotatable electronic owl 11.

A plurality of protrusions 18 extend outwardly from a bottom portion of the base 14. These protrusions 18 are adapted to engage with the surface on which the device 11 is to be installed. The protrusions 18 may be utilized to penetrate the ground surface or exterior of rigid surface for a more secure installation. In the illustrated embodiment, the bottom of the base 14 comprises a planar surface. However, in alternate embodiments of the device 11, the bottom of the base 14 may be shaped to fit the bottom surface of an angled rooftop.

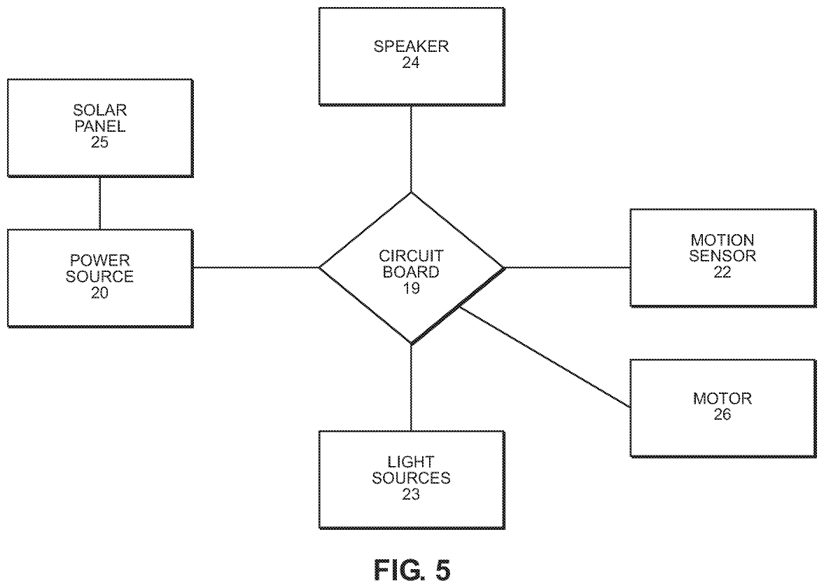

Referring now to FIG. 5, there is shown a schematic view of the electronic components of an embodiment of the weighted rotatable electronic owl. A circuit board 19 is operably connected to a power source 20 and disposed within the hollow interior of the body portion of the device. A plurality of motion sensors 22 are included on a surface of the body portion 12 and operably connected to the circuit board 19. These sensors 22 are configured to detect motion within a specified range around the weighted rotatable electronic owl. A pair of light sources 23 are embedded within the head member corresponding to the location of the owl's eyes. These light sources 23 are operably connected to the circuit board 19 and configured to illuminate for a specified duration when motion is detected by the sensors 22. A pair of speakers 24 are disposed within the head member on opposing sides of the head member that correspond with an owl's tuft feathers. These speakers 24 are operably connected to the circuit board 19 disposed within the body portion. A motor 26 is also operably attached to the circuit board 19 and configured to rotate the head member. In the illustrated embodiment, a solar panel 25 is disposed on a top portion of the head member 13 and operably connected to the power source 20.

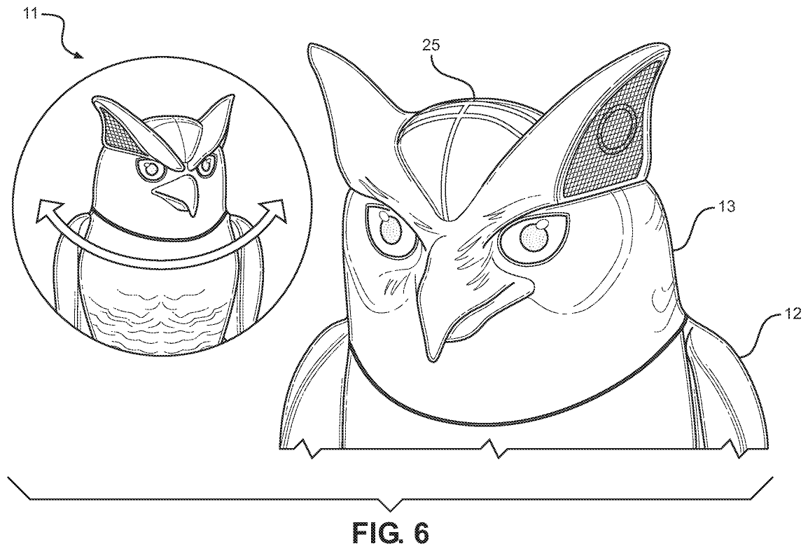

Referring now to FIG. 6, there is shown a perspective view of an embodiment of the weighted rotatable electronic owl showing head member. The motor, which is operably connected to the circuit board, is disposed within the body portion 12 of the device 11 is configured to rotate the head member 13. The head member 13 is rotatably affixed to the top end of the body portion 12 and adapted to rotate along a perimeter thereof in a 360-degree fashion. Operation of the rotation of the head member 13 is performed by the motor which is connected to a drive axle attached to the frame of the head member 13. Solar panels 25 are disposed on a top end of the head member 13. Energy collected from the solar panels 25 during the daytime hours are used to recharge the power source of the weighted rotatable electronic owl 11.

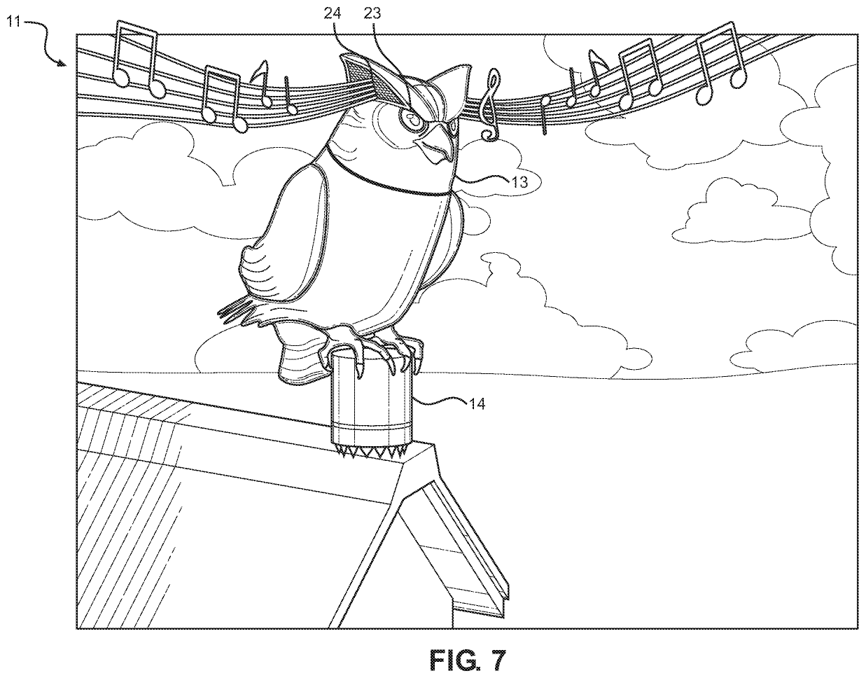

Referring now to FIG. 7, there is shown a perspective view of an embodiment of the weighted rotatable electronic owl installed on the exterior of a building. In practice, the device 11 is adapted to be weighted down and installed in outdoor environments and on exterior structures. The weighted rotatable electronic owl 11 may be placed in back yard and gardens by penetrating the protrusions extending outward from the bottom of the base 14 into a ground surface. The device 11 may also be mounted on a ledge or other exterior surface of a building or structure where a user may desire to frighten away pigeons and other pest animals to discourage nesting or gathering. In practice, an installed weighted rotatable electronic owl 11 will detect nearby pigeons and pest animals using the sensors disposed about the body portion 12. When moving objects are detected within range of the sensors, the head member 13 will rotate in the direction that the motion has been detected for a brief period before returning to a starting position corresponding to a front facing owl. Upon detection by the sensors, the light sources 23 within the head member 13 will illuminate for a brief period while simultaneously a recorded owl screech will be played through the speakers 24 also disposed on the head member 13. In some embodiments of the weighted rotatable electronic owl 11, any combination of the rotation, illumination, or sound projection from the head member 13 may be done each time the sensor is triggered.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A weighted rotatable electronic owl, comprising:
a body portion having a top end disposed oppositely a bottom end;
the body portion defining an interior volume;
a head member rotatably attached to the top end of the body portion;
a base disposed on the bottom end of the body portion wherein the base is removably attachable to the body portion;
a plurality of protrusions extending outward from a bottom surface of the base;
a power source having a circuit board operably connected thereto disposed within the interior volume of the body portion;
a motor operably connected to the circuit board and configured to rotate the head member.

2) The weighted rotatable electronic owl of claim 1, wherein the base member comprises a housing that defines a hollow compartment.

3) The weighted rotatable electronic owl of claim 1, wherein the base member is cylindrical in shape.

4) The weighted rotatable electronic owl of claim 2, wherein an aperture within the base is adapted to receive at least one weight therethrough into the hollow compartment of the base.

5) The weighted rotatable electronic owl of claim 4, wherein the aperture is removably closable via a plug.

6) The weighted rotatable electronic owl of claim 4, wherein the aperture is concealed by the body portion when the base is removably secured to the body portion.

7) The weighted rotatable electronic owl of claim 1, wherein at least one motion sensor is disposed on an exterior surface of the body portion and operably connected to the circuit board wherein the sensors are configured to detect motion within a given proximity.

8) The weighted rotatable electronic owl of claim 7, wherein the head member is configured to rotatably swivel into the direction that motion is detected by the plurality of sensors.

9) The weighted rotatable electronic owl of claim 7, wherein speakers disposed within the head or body portion of the device and operably connected to the circuit board are configured to emit the sound of a predator when motion is detected within a given proximity.

10) The weighted rotatable electronic owl of claim 1, wherein the plurality of protrusions are spikes configured to engage or penetrate the surface the device is resting upon.

11) The weighted rotatable electronic owl of claim 1, wherein the motor is configured to rotate the head member in a 360-degree fashion around the top of the body portion via an axle affixed from the motor to the head portion.

12) The weighted rotatable electronic owl of claim 1, wherein a pair of light sources are disposed on the head member corresponding to the eye placements and operably attached to the circuit board.

13) The weighted rotatable electronic owl of claim 13, wherein the light sources are configured to illuminate for a short duration upon the detection of movement.

14) The weighted rotatable electronic owl of claim 1, wherein the device can be configured to rotate, illuminate, emit predator noises, or any combination these upon detection of motion within a given proximity.

15) The weighted rotatable electronic owl of claim 1, wherein the power source comprises a rechargeable battery.

16) The weighted rotatable electronic owl of claim 16, wherein solar panels disposed on the top of the head member off the device are operably attached to the power source and configured to recharge depleted batteries.
